(19) United States
(12) Patent Application Publication
(10) Pub. No.: US 2014/0364675 A1
(43) Pub. Date: Dec. 11, 2014

(54) METHODS AND PRODUCTS FOR SOLIDIFICATION OF WASTE PAINT

(71) Applicants: Robert Toby Wilson, Riverdale, UT (US); Tommy S. Cheng, Fontana, CA (US)

(72) Inventors: Robert Toby Wilson, Riverdale, UT (US); Tommy S. Cheng, Fontana, CA (US)

(21) Appl. No.: 14/300,491

(22) Filed: Jun. 10, 2014

Related U.S. Application Data
(60) Provisional application No. 61/833,199, filed on Jun. 10, 2013.

(51) Int. Cl. B09B 3/00; A62D 3/02

(52) U.S. Cl. CPC B09B 3/0033; A62D 3/02
USPC 588/252

(57) ABSTRACT

Methods and products for hardening/solidifying waste paint for disposal, which are ideal for use with water-based paints, acrylic paints, latex paints and oil-based paints using a single product which is both safe to use and safe for landfill disposal. In one illustrative embodiment, the product may comprise coconut coir, manufactured in a loose granulated grade, a compressed pellet grade, or a suitable mixture thereof which allows a user to choose the correct grades desired for as specific application to solidify waste paint materials safe for landfill disposal. Methods of use may include selecting the appropriate grade for a particular usage, solidifying waste paint and disposing of the waste paint absorbed into the selected coconut coir product.

### CROSS REFERENCE TO RELATED APPLICATIONS

This application claims priority to and incorporates by reference all of the subject matter included in Provisional Patent Application Ser. No. 61/833,199, which was filed Jun. 10, 2013.

### TECHNICAL FIELD

The present disclosure relates to products and methods for the disposal of waste paint.

### BACKGROUND

The currently used product for hardening waste paint for cleanup or disposal is Sodium PolyAcrylate, which needs water to act as a catalyst to produce a chemical reaction for effective hardening. While it may function well for water-based paints, it can be ineffective for hardening other paints, including oil-based paints.

Methods and products that allowed for the hardening and cleanup of various paint types with a single common material would be an improvement in the art. Such methods or products that allowed for the absorbed paint to be disposed of in a standard fashion as a non-hazardous waste would be a further improvement in the art.

### SUMMARY

The present disclosure is directed to methods and products for hardening/solidifying waste paint for disposal, which are ideal for use with water-based paints, acrylic paints, latex paints and oil-based paints using a single product which is both safe to use and safe for landfill disposal. In one illustrative embodiment, the product may comprise coconut coir, manufactured in a loose granulated grade, a compressed pellet grade, or a suitable mixture thereof which allows a user to choose the correct grades desired for as specific application to solidify waste paint materials safe for landfill disposal. Methods of use may include selecting the appropriate grade for a particular usage, solidifying waste paint and disposing of the waste paint absorbed into the selected coconut coir product.

In another illustrative embodiment, a product may include coir in a proportion of from about 85% to about 99% and a suitable microbe for initiating bioremediation of the absorbed paint in an appropriate form in a proportion of from about 20% to about 1%, by weight. Methods of using a product may include absorbing waste paint fluid with the product then disposing of the product with the absorbed waste paint where the microbe will perform bioremediation. This may allow the absorption (cleanup) of waste paint in residential, commercial and industrial applications and the peace of mind of using a safe, sustainable, environmentally friendly, landfill safe product.

### DETAILED DESCRIPTION

The present disclosure relates to apparatus, systems and methods related to absorbent products disposal of waste paint. It will be appreciated by those skilled in the art that the embodiments herein described, while illustrative, are not intended to so limit the scope of the appended claims. Those skilled in the art will also understand that various combinations or modifications of the embodiments presented herein can be made without departing from the scope of this disclosure. All such alternate embodiments are within the scope of the appended claims.

The present disclosure is directed to methods and products for hardening paint. In some embodiments, a product for hardening paint may primarily be formed from coconut coir fiber pith having a moisture content of from about 15% to about 20%. In a first embodiment, the coir fiber may be in a loose granulated form having a bulk density range of about 7 lbs/cubic foot to about 12 lbs/cubic foot. In other embodiments, the primary ingredient may be coconut coir pith formed into compressed pellets. Suitable pellets may be formed using a 7:1 compression ratio to produce a product with a density of from about 20 lbs/cubic foot to about 35 lbs/cubic foot. The pellets may have varying diameters from about ⅛ inch to about ½ inch and varying lengths depending on application requirements. Other embodiments may include a mixture of pellet and granulated coir in varying amounts to achieve desired absorption speed and properties. For use, a suitable amount of product is added to waste paint to absorb the paint to form a hardened mass which can be cleaned up by sweeping or hand.

In other embodiments, a bioremediating absorbent material in accordance with the present disclosure may contain coconut coir, such as Coconut Coir Fiber Pith having a moisture content of from about 15% to about 20% H₂O, as discussed above. It may also contain one or more microbes for breaking down the absorbed waste paint waste in a suitable form and amount for beginning bioremediation of waste paint absorbed into the coir. Suitable microbes include bacteria in a dormant state, or bacterial spores. A blend of one or more microbes may be used for additional or increased functionality. One example of a suitable blend that may be used is the commercially available BI-CHEM® SB Concentrate from Novozymes®. This concentrate is sold as a powder intended as a dry septic and waste degrader and is a blend of Bacillus spores characterized with a bacteria count: of about 10.0×10⁹ cfu/gram. The included microbes produce Lipase, Protease, Amylase, and/or Cellulase and are capable of both aerobic and facultative anaerobic digestion. It will be appreciated that other suitable microbes may be used and are within the scope of the present invention.

Upon absorption, the resulting hardened paint and product may be dry to the touch as the coconut coir's superior and rapid absorption of moisture will turn absorbed paint into a solid substance comprising coir and absorbed paint. This solid cannot “re-wet,” so the paint will not return to its liquid form even if it comes into contact with liquids, such as upon exposure when contained in a landfill. This result is achieved through the coconut coir's porous structure providing greater surface area and surface tension. Also, because the coconut coir's particulate structure can increase up to nine times its own mass during absorption, this allows for encapsulation. Due to the materials non-leaching characteristics, it makes this product ideal for solidifying water-based paints, acrylic paints, latex paints and oil-based paints, but not limited to, for disposal in landfills in an environmentally responsible way.

While currently used paint hardener materials, such as Sodium PolyAcrylate, need water as a catalyst to produce a chemical reaction to be effective, products in accordance with the present invention do not rely on water or another catalyst to produce a chemical reaction. Further, as the primary ingredient naturally occurring material from coconut fruit, the products are safe to use and do not require special handling instructions or precautions.

Testing of products in accordance with the present disclosure show that embodiments meet and exceed federal EPA leachate standards for water-based paints, acrylic paints, latex paints and oil-based paints thus providing additional protection against landfill contamination.

### EXAMPLE I

A loose granular form of product was saturated with automotive paint. A sample was then subjected to TCLP analysis. Results are depicted in the following table:

| | |
|---|---|
| Coco Absorb LLC | PO#/Project Name: TCLP-Car Paint Absorbed |
| | in Coconut Husk |
| Robert Toby Wilson | Date/Time Received: 6/27/2012 13:30 |
| 3974S 900W | Date Repotted: 7/10/2012 |
| Riverdale, UT 84405 | |

Sample Name: CocoAbsorb Saturated in Car Paint Lab ID#: 179019
Collected: 6/27/2012 13:30 Matrix: Solid

| | | Analysis | | | | |
|---|---|---|---|---|---|---|
| Parameter | Method | Date/Time | MRL | Units | Results | Flags |
| TCLP Prep Metals | 1311/ | 7/9/2012 | | | | |
| | 3010A/ | | | | | |
| | 3020A | | | | | |
| TCLP Arsenic | 6010B | 7/10/2012 | 0.2 | mg/L | <0.02 | |
| TCLP Barium | 6010B | 7/10/2012 | 0.01 | mg/L | 0.060 | |
| TCLP Cadmium | 6010B | 7/10/2012 | 0.02 | mg/L | <0.02 | |
| TCLP Chromium | 6010B | 7/10/2012 | 0.05 | mg/L | <0.05 | |
| TCLP Lead | 6010B | 7/10/2012 | 0.05 | mg/L | <0.05 | |
| TCLP Mercury | 7471A | 7/10/2012 | 0.05 | mg/L | <0.05 | |
| TCLP Selenium | 6010B | 7/10/2012 | 0.05 | mg/L | <0.05 | |
| TCLP Silver | 6010B | 7/10/2012 | 0.05 | mg/L | <0.05 | |

product by the testing procedure.

### EXAMPLE II

Samples of a product are prepared by mixing about 1.0 pounds of shredded coconut coir with about 0.8., 1.6, 2.4, 3.2 and 4.0 ounces of Novozymes® BI-CHEM® SB Concentrate to achieve about ratios of about 5%, 10%, 15%, 20%, and 25% by weight, respectively. A sufficient amount of each sample is used to absorb a 100 mL of oil based paint oil in a container to simulate waste paint in the bottom of a paint can. The sample is placed in a sealed container to maintain an anaerobic condition. The sample is analyzed at suitable time intervals to determine if bioremediation of the absorbed paint is occurring. Analysis shows that breakdown of the paint occurs as expected.

While this invention has been described in certain embodiments, the present invention can be further modified with the spirit and scope of this disclosure. This application is therefore intended to cover any variations, uses, or adaptations of the invention using its general principles. Further, this application is intended to cover such departures from the present disclosure as come within known or customary practices in the art to which this invention pertains and which fall within the limits of the appended claims.

1. (canceled)

2. A method of disposing of waste paint, comprising:
selecting a product comprising coconut coir;
absorbing waste paint with the selected product such that the waste paint and selected product form a hardened mass; and
disposing of the waste paint absorbed into the selected coconut coir product.

3. The method of claim 2, wherein selecting a product comprising coconut coir comprises selecting a product comprising loose granulated coconut coir, coconut coir formed into compressed pellets, or a mixture of loose granulated and coconut coir compressed pellets.

4. The method of claim 3, wherein the loose granulated coconut coir has a moisture content of from about 15% to about 20% H₂O.

5. The method of claim 3, wherein the loose granulated coconut coir has a density of from about 7 lbs/cubic foot to about 12 lbs/cubic foot.

6. The method of claim 3, wherein the compressed pellets have a density of from about 20 lbs/cubic foot to about 35 lbs/cubic foot.

7. The method of claim 3, wherein the compressed pellets have varying diameters from about ⅛ inch to about ½ inch.

8. The method of claim 2, wherein selecting a product comprising coconut coir comprises selecting a product comprising coconut coir and at least one type of microbe for bioremediation of the waste paint.

9. The method of claim 8, wherein selecting a product comprising coconut coir and at least one type of microbe for bioremediation of the waste paint comprises selecting a product comprising bacteria in a dormant state or bacterial spores.

10. The method of claim 8, wherein selecting a product comprising coconut coir and at least one type of microbe for bioremediation of the waste paint comprises selecting a product comprising a blend of one or more different types of microbes.

11. The method of claim 2, wherein absorbing waste paint with the selected product such that the waste paint and selected product form a hardened mass comprises turning the selected product and the waste paint into a combined solid substance.

12. The method of claim 2, wherein absorbing waste paint with the selected product such that the waste paint and selected product form a hardened mass comprises encapsulating the waste paint within the selected product.

13. The method of claim 12, wherein encapsulating the waste paint within the selected product comprises retaining the waste paint in a manner that exceeds federal EPA leachate standards.

14. The method of claim 2, wherein disposing of the waste paint absorbed into the selected coconut coir product comprises disposing the hardened mass into a landfill.

15. A method of disposing of waste paint, comprising:
encapsulating waste paint in an absorbent product comprising coconut coir to form a combined solid substance, and
disposing of the combined solid substance in a landfill.

16. The method of claim 15, wherein encapsulating waste paint in an absorbent product comprising coconut coir comprises encapsulating waste paint in an absorbent product comprising coconut coir comprising loose granulated coconut coir, coconut coir formed into compressed pellets, or a mixture of loose granulated and coconut coir compressed pellets.

17. The method of claim 16, wherein the loose granulated coconut coir has a moisture content of from about 15% to about 20% H₂O and a density of from about 7 lbs/cubic foot to about 12 lbs/cubic foot.

18. The method of claim 16, wherein the compressed pellets have a density of from about 20 lbs/cubic foot to about 35 lbs/cubic foot and varying diameters from about ⅛ inch to about ½ inch.

19. The method of claim 15, wherein encapsulating waste paint in an absorbent product comprising coconut coir comprises encapsulating waste paint in an absorbent product comprising coconut coir and at least one type of microbe selected for bioremediation of the waste paint.

20. The method of claim 19, wherein comprising coconut coir and at least one type of microbe selected for bioremediation of the waste paint comprise encapsulating waste paint in an absorbent product comprising coconut coir and bacteria in a dormant state or bacterial spores.

21. The method of claim 15, wherein encapsulating encapsulating waste paint in an absorbent product comprising coconut coir comprises retaining the waste paint in a manner that exceeds federal EPA leachate standards.
